(19) United States
(12) Patent Application Publication
(10) Pub. No.: US 2026/0235077 A1
(43) Pub. Date: Aug. 13, 2026

(54) FUEL NOZZLE FOR MULTIFUEL FUEL DELIVERY SYSTEM

(71) Applicant: Pratt & Whitney Corp, Longueuil, Quebec (CA)

(72) Inventors: Jayaprakash Kannan, North York (CA); Owen Kannan, North York (CA)

(21) Appl. No.: 19/228,344

(22) Filed: Jun. 4, 2025

Related U.S. Application Data
(60) Provisional application No. 63/655,827, filed on Jun. 4, 2024.

(51) Int. Cl. F02C 7/22; B64D 37/00

(52) U.S. Cl. CPC F02C 7/222; B64D 37/005

(57) ABSTRACT

An apparatus is provided for a powerplant. This apparatus includes a fuel nozzle extending longitudinally along a centerline to a distal end. The fuel nozzle includes a plurality of gaseous fuel passages, a plurality of liquid fuel passages, an annular passage and a nozzle outlet disposed at the distal end of the fuel nozzle. The gaseous fuel passages are arranged circumferentially about the centerline. Each of the gaseous fuel passages extends within the fuel nozzle to the annular passage. The liquid fuel passages are arranged circumferentially about the centerline. Each of the liquid fuel passages extends within the fuel nozzle to the annular passage. The annular passage extends circumferentially around the centerline. The annular passage fluidly couples the gaseous fuel passages and the liquid fuel passages to the nozzle outlet.

This application claims priority to U.S. Patent Appln. No. 63/655,827 filed Jun. 4, 2024 which is hereby incorporated herein by reference in its entirety.

### TECHNICAL FIELD

This disclosure relates generally to a turbine engine and, more particularly, to a fuel delivery system for the turbine engine.

### BACKGROUND INFORMATION

A gas turbine engine includes one or more fuel nozzles for injecting fuel into a combustor for combustion. Various types of fuel nozzles are known in the art. In addition, various types of fuel delivery systems are known in the art for delivering multiple fuels to the combustor for injection. While these known fuel nozzles and fuel delivery systems have various benefits, there is still room in the art for improvement.

### SUMMARY

According to an aspect of the present disclosure, an apparatus is provided for a powerplant. This apparatus includes a fuel nozzle extending longitudinally along a centerline to a distal end. The fuel nozzle includes a plurality of gaseous fuel passages, a plurality of liquid fuel passages, an annular passage and a nozzle outlet disposed at the distal end of the fuel nozzle. The gaseous fuel passages are arranged circumferentially about the centerline. Each of the gaseous fuel passages extends within the fuel nozzle to the annular passage. The liquid fuel passages are arranged circumferentially about the centerline. Each of the liquid fuel passages extends within the fuel nozzle to the annular passage. The annular passage extends circumferentially around the centerline. The annular passage fluidly couples the gaseous fuel passages and the liquid fuel passages to the nozzle outlet.

According to another aspect of the present disclosure, an apparatus is provided for an aircraft powerplant. This apparatus includes a fuel nozzle extending longitudinally along a centerline to a distal end. The fuel nozzle includes a plurality of first fuel passages, a plurality of second fuel passages, a first fuel gallery, a second fuel gallery, an annular passage and a nozzle outlet disposed at the distal end of the fuel nozzle. The first fuel passages are arranged circumferentially about the centerline. Each of the first fuel passages extends within the fuel nozzle from the first fuel gallery to the annular passage. The second fuel passages are arranged circumferentially about the centerline. Each of the second fuel passages extends within the fuel nozzle from the second fuel gallery to the annular passage. The annular passage extends circumferentially around the centerline. The annular passage fluidly couples the first fuel passages and the second fuel passages to the nozzle outlet. The annular passage radially tapers towards the centerline as the annular passage extends longitudinally towards the nozzle outlet.

According to still another aspect of the present disclosure, an apparatus is provided for an aircraft powerplant. This apparatus includes a fuel nozzle extending longitudinally along a centerline to a distal end. The fuel nozzle includes a plurality of first fuel passages, a plurality of second fuel passages, an annular passage and a nozzle outlet disposed at the distal end of the fuel nozzle. The first fuel passages are arranged circumferentially about the centerline. Each of the first fuel passages extends within the fuel nozzle, in a radial inward direction towards the centerline, to the annular passage. The second fuel passages are arranged circumferentially about the centerline. Each of the second fuel passages extends within the fuel nozzle, in a longitudinal direction towards the distal end of the fuel nozzle, to the annular passage. The annular passage extends circumferentially around the centerline. The annular passage fluidly couples the first fuel passages and the second fuel passages to the nozzle outlet. The annular passage radially tapers towards the centerline as the annular passage extends longitudinally to the nozzle outlet.

A radial height of the annular passage may decrease as the annular passage extends longitudinally along the centerline in a direction towards the nozzle outlet.

The annular passage may extend radially between an inner side and an outer side. A radius from the centerline to the inner side of the annular passage may decrease as the annular passage extends longitudinally to the nozzle outlet.

The annular passage may extend radially between an inner side and an outer side. A radius from the centerline to the outer side of the annular passage may decrease as the annular passage extends longitudinally to the nozzle outlet.

The nozzle outlet may extend radially from the centerline to an outer side of the nozzle outlet.

The outer side of the nozzle outlet may be at least within fifteen degrees of parallel of the centerline when viewed in a reference plane parallel with the centerline.

The nozzle outlet may extend radially between an inner side of the nozzle outlet and an outer side of the nozzle outlet.

The inner side of the nozzle outlet may be at least within fifteen degrees of parallel of the centerline when viewed in a reference plane parallel with the centerline. In addition or alternatively, the outer side of the nozzle outlet may be at least within fifteen degrees of parallel of the centerline when viewed in the reference plane.

The fuel nozzle may also include a plurality of vanes disposed within the annular passage and arranged circumferentially about the centerline. Each of the vanes may extend radially across the annular passage.

The annular passage may extend longitudinally along the centerline from an upstream end to the nozzle outlet. The gaseous fuel passages may be fluidly coupled to the annular passage at the upstream end of the annular passage. The liquid passages may be fluidly coupled to the annular passage at the upstream end of the annular passage.

The gaseous fuel passages may include a first gaseous fuel passage. The first gaseous fuel passage may extend radially inward towards the centerline to the annular passage.

The gaseous fuel passages may include a first gaseous fuel passage. The first gaseous fuel passage may extend longitudinally along the centerline to the annular passage.

The fuel nozzle may also include a gaseous fuel gallery extending circumferentially about the centerline. Each of the gaseous fuel passages may extend from the gaseous fuel gallery to the annular passage.

The liquid fuel passages may include a first liquid fuel passage. The first liquid fuel passage may extend longitudinally along the centerline to the annular passage.

The fuel nozzle may also include a liquid fuel gallery extending circumferentially about the centerline. Each of the liquid fuel passages may extend from the liquid fuel gallery to the annular passage.

The apparatus may also include a fuel system, and the fuel system may include a gaseous fuel source and a liquid fuel source. The fuel system may be configured to deliver gaseous fuel from the gaseous fuel source to the fuel nozzle for directing through the gaseous fuel passages. The fuel system may be configured to deliver liquid fuel from liquid fuel source to the fuel nozzle for directing through the plurality of liquid fuel passages.

The gaseous fuel may be or otherwise include hydrogen fuel. In addition or alternatively, the liquid fuel may be or otherwise include hydrocarbon fuel.

The fuel system may be configured to deliver the gaseous fuel and the liquid fuel simultaneously to the fuel nozzle during a mode of operation.

The fuel system may be configured to deliver the gaseous fuel to the fuel nozzle without delivering the liquid fuel to the fuel nozzle during a first mode of operation. In addition or alternatively, the fuel system may be configured to deliver the liquid fuel to the fuel nozzle without delivering the gaseous fuel to the fuel nozzle during a second mode of operation.

The annular passage may be a first annular passage. The fuel nozzle may also include a plurality of air passages and a second annular passage. The air passages may be arranged circumferentially about the centerline. Each of the air passages may extend within the fuel nozzle to the second annular passage. The first annular passage may circumscribe the second annular passage.

The fuel nozzle may also include a plurality of air passages and a recess which extends longitudinally into the fuel nozzle at the distal end of the fuel nozzle. The air passages may be arranged circumferentially about the centerline. Each of the air passages may extend through a wall of the fuel nozzle to the recess. The recess may fluidly couple the nozzle outlet and the air passages to an environment external to the fuel nozzle.

The present disclosure may include any one or more of the individual features disclosed above and/or below alone or in any combination thereof.

The foregoing features and the operation of the invention will become more apparent in light of the following description and the accompanying drawings.

### BRIEF DESCRIPTION OF THE DRAWINGS

FIG. 1 is a partial schematic illustration of an aircraft powerplant.

FIG. 2 is a schematic illustration of a combustor with a fuel delivery system.

FIG. 3 is a sectional illustration of a portion of a combustor section with the fuel delivery system.

FIG. 4 is a sectional illustration of a fuel nozzle.

FIG. 5 is a cross-sectional illustration of a portion of the fuel nozzle at an upstream end of a multifuel passage.

FIG. 6 is a partial sectional illustration of another fuel nozzle.

FIGS. 7A and 7B are partial sectional illustrations of the fuel nozzle without and with vanes within its multifuel passage.

FIG. 8 is a partial sectional illustration of another fuel nozzle.

### DETAILED DESCRIPTION

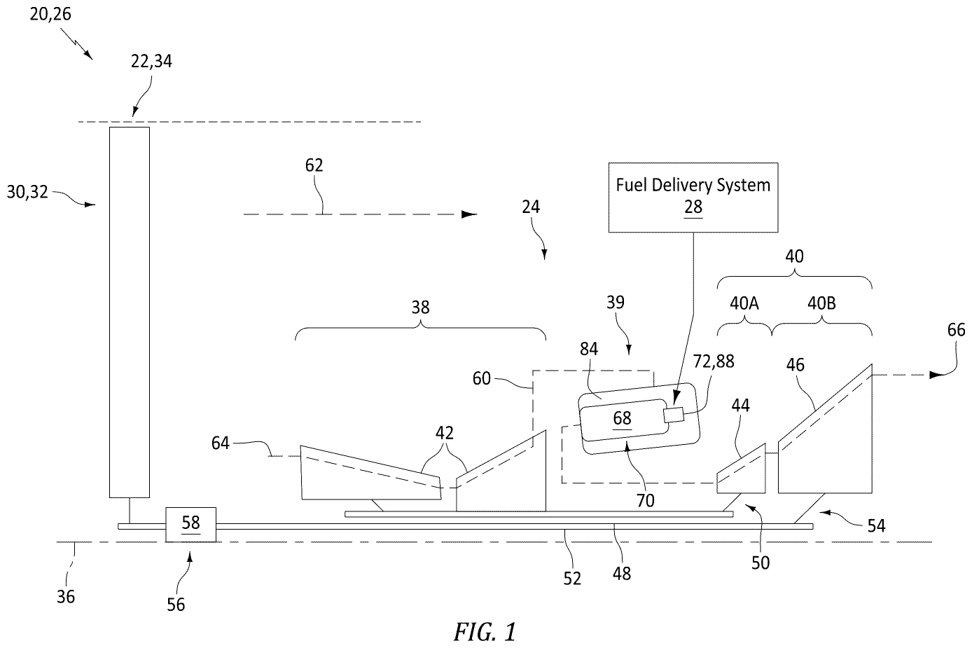

FIG. 1 illustrates a powerplant 20 for an aircraft. The aircraft may be an airplane, a helicopter, a drone (e.g., an unmanned aerial vehicle (UAV)) or any other manned or unmanned aerial vehicle or system. The powerplant 20 may be configured as, or otherwise included as part of, a propulsion system for the aircraft. The powerplant 20 may also or alternatively be configured as, or otherwise included as part of, an electrical power system for the aircraft. The present disclosure, however, is not limited to aircraft applications. The powerplant 20, for example, may alternatively be configured as, or otherwise included as part of, an electrical power system for ground-based operation (e.g., an industrial powerplant), for aquatic operation, or otherwise. However, for ease of description, the powerplant 20 is described below as an aircraft powerplant.

The aircraft powerplant 20 of FIG. 1 includes a mechanical load 22 and a core 24 of a gas turbine engine 26, where the engine core 24 is configured to power operation of the mechanical load 22. The aircraft powerplant 20 also includes a fuel delivery system 28 for the turbine engine 26 and its engine core 24.

The mechanical load 22 may be configured as or otherwise include a rotor 30 mechanically driven by the engine core 24. This driven rotor 30 may be a bladed propulsor rotor for the aircraft propulsion system. The propulsor rotor may be a ducted propulsor rotor or an open propulsor rotor; e.g., an un-ducted propulsor rotor. For example, where the turbine engine 26 is a turbofan engine, the ducted propulsor rotor may be a fan rotor 32. Where the turbine engine 26 is a turboprop engine, the open propulsor rotor may be a propeller rotor. Where the turbine engine 26 is a turboshaft engine, the open propulsor rotor may be a rotorcraft rotor such as a helicopter main rotor or a helicopter tail rotor. Alternatively, the driven rotor 30 may be configured as a generator rotor of an electric power generator for the aircraft electrical power system; e.g., an auxiliary power unit (APU) system. The present disclosure, however, is not limited to the foregoing exemplary mechanical loads nor to the foregoing exemplary turbine engines. The turbine engine 26, for example, may alternatively be configured as a turbojet engine, a propfan engine, a pusher fan engine or any other type of turbine engine operable to power the operation of the mechanical load 22. However, for ease of description, the mechanical load 22 is described below as a fan section 34 of the turbine engine 26, and the driven rotor 30 is described below as the fan rotor 32 within the fan section 34.

The turbine engine 26 extends axially along an axis 36 from a forward, upstream end of the turbine engine 26 to an aft, downstream end of the turbine engine 26. Briefly, this axis 36 may be a centerline axis of the turbine engine 26 and its members 24 and 32. The axis 36 may also be a rotational axis of one or more members of the turbine engine 26 and its engine core 24 including the fan rotor 32—the driven rotor 30. The turbine engine 26 of FIG. 1 includes the fan section 34, a compressor section 38, a combustor section 39 and a turbine section 40. The turbine section 40 of FIG. 1 includes a high pressure turbine (HPT) section 40A and a low pressure turbine (LPT) section 40B, which LPT section 40B of FIG. 1 is a power turbine (PT) section for driving rotation of the fan rotor 32.

The compressor section 38 includes a compressor rotor 42. The HPT section 40A includes a high pressure turbine (HPT) rotor 44. The LPT section 40B includes a low pressure turbine (LPT) rotor 46. The fan rotor 32, the compressor rotor 42, the HPT rotor 44 and the LPT rotor 46 each respectively include one or more arrays (e.g., stages) of rotor blades, where the rotor blades in each array are arranged circumferentially around and are connected to a respective rotor disk or hub. The rotor blades in each array, for example, may be formed integral with or mechanically fastened, welded, brazed and/or otherwise attached to the respective rotor disk and/or hub.

The compressor rotor 42 is coupled to and rotatable with the HPT rotor 44. The compressor rotor 42 of FIG. 1, for example, is connected to the HPT rotor 44 by a high speed shaft 48. At least (or only) the compressor rotor 42, the HPT rotor 44 and the high speed shaft 48 collectively form a high speed rotating assembly 50; e.g., a high speed spool of the engine core 24. The LPT rotor 46 of FIG. 1 is connected to a low speed shaft 52. At least (or only) the LPT rotor 46 and the low speed shaft 52 collectively form a low speed rotating assembly 54; e.g., a low speed spool/a power turbine spool of the engine core 24. This low speed rotating assembly 54 is further coupled to the fan rotor 32—the driven rotor 30—through a drivetrain 56. This drivetrain 56 may be configured as a geared drivetrain, where a geartrain 58 (e.g., a transmission, a speed change device, an epicyclic geartrain, etc.) is disposed between and operatively couples the fan rotor 32 to the low speed rotating assembly 54 and its LPT rotor 46. With this arrangement, the fan rotor 32 may rotate at a different (e.g., slower) rotational velocity than the low speed rotating assembly 54 and its LPT rotor 46. However, the drivetrain 56 may alternatively be configured as a direct drive drivetrain, where the geartrain 58 is omitted. With such an arrangement, the fan rotor 32 rotates at a common (the same) rotational velocity as the low speed rotating assembly 54 and its LPT rotor 46. Referring again to FIG. 1, each of the rotating assemblies 50, 54 and its members as well as the fan rotor 32 may be rotatable about the axis 36.

The turbine engine 26 of FIG. 1 includes a (e.g., annular) core flowpath 60 and a (e.g., annular) bypass flowpath 62. Here, the bypass flowpath 62 is a ducted flowpath within the aircraft powerplant 20 and its turbine engine 26. The bypass flowpath 62, however, may alternatively be an open flowpath where the driven rotor 30 is alternatively configured as the open propulsor rotor, or the bypass flowpath 62 may be omitted where the driven rotor 30 is alternatively configured as the generator rotor. Referring again to FIG. 1, the core flowpath 60 extends within the turbine engine 26 and its engine core 24 from an airflow inlet 64 into the core flowpath 60 to a combustion products exhaust 66 from the core flowpath 60. More particularly, the core flowpath 60 extends from the core inlet 64, sequentially through the compressor section 38, the combustor section 39, the HPT section 40A and the LPT section 40B, to the core exhaust 66. The bypass flowpath 62 of FIG. 1 extends outside of the engine core 24 thereby bypassing the engine core 24 and its engine sections 38-40B.

During operation of the turbine engine 26, air is directed across the fan rotor 32 (e.g., the propulsor rotor) and into the engine core 24 through the core inlet 64. This air entering the core flowpath 60 may be referred to as core air. The core air is compressed by the compressor rotor 42 and directed into a combustion chamber 68 (e.g., an annular combustion chamber) within a combustor 70 (e.g., an annular combustor) of the combustor section 39. Fuel is injected into the combustion chamber 68 by one or more fuel injectors 72 and mixed with the compressed core air to provide a fuel-air mixture. This fuel-air mixture is ignited and combustion products thereof flow through and sequentially drive rotation of the HPT rotor 44 and the LPT rotor 46. The rotation of the HPT rotor 44 drives rotation of the compressor rotor 42 and, thus, the compression of the air received from the core inlet 64. The rotation of the LPT rotor 46 drives rotation of the fan rotor 32—the driven rotor 30. The rotation of the fan rotor 32 propels some of the air flow thereacross (e.g., the air not entering the engine core 24) through the bypass flowpath 62 to provide engine thrust. Of course, where the driven rotor 30 is alternatively configured as the open propulsor rotor, the rotation of this open propulsor rotor may propel air outside of the aircraft powerplant 20 and its turbine engine 26. Where the driven rotor 30 is alternatively configured as the generator rotor, the rotation of this generator rotor may facilitate generation of electricity.

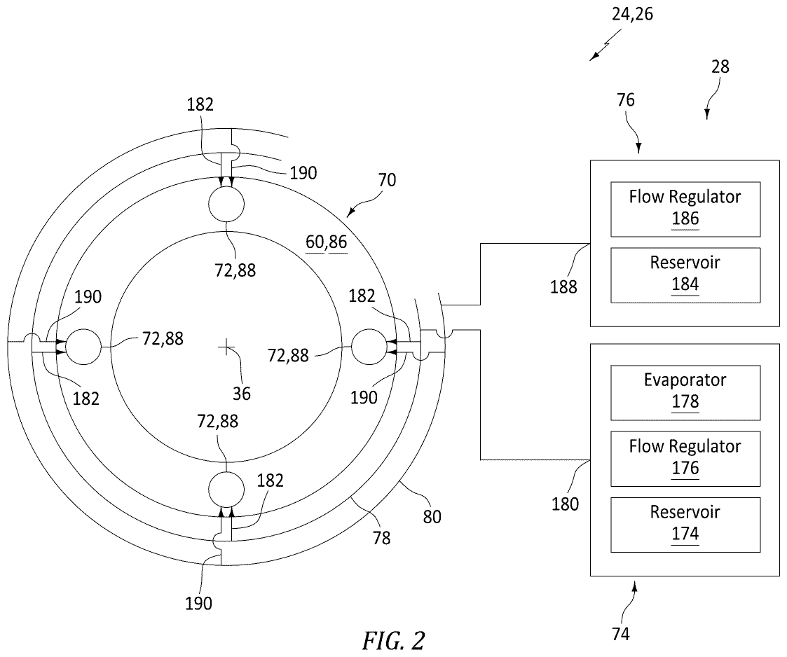

Referring to FIG. 2, the fuel delivery system 28 is configured to deliver the fuel to the combustor 70 for combustion as described above. This fuel may be a gaseous fuel, a liquid fuel or both the gaseous fuel and the liquid fuel. The fuel delivery system 28 of FIG. 2, for example, includes the one or more fuel injectors 72. This fuel delivery system 28 also includes a gaseous fuel source 74, a liquid fuel source 76, a gaseous fuel manifold 78 and a liquid fuel manifold 80.

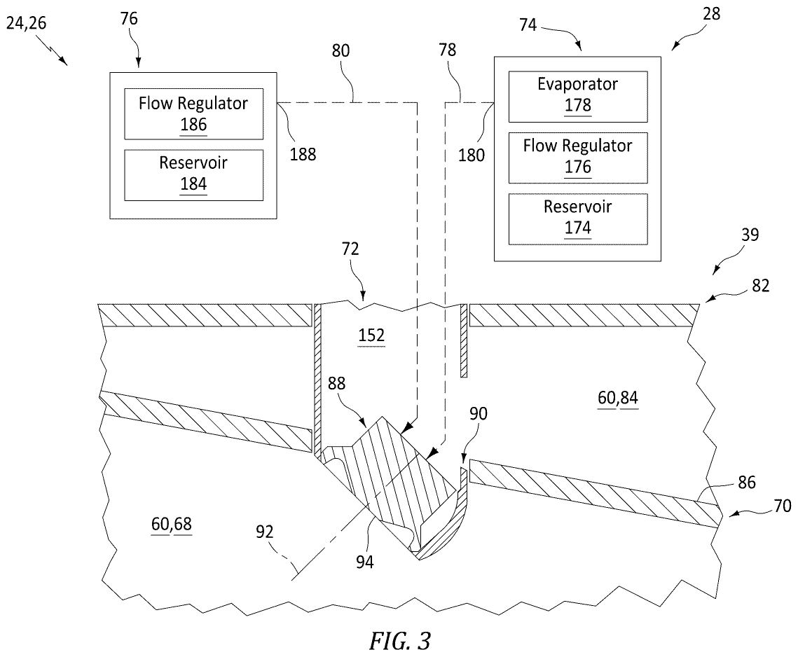

The fuel injectors 72 of FIG. 2 are arranged and may be equispaced circumferentially about the axis 36 in an annular array; e.g., a circular array. Referring to FIG. 3, each of the fuel injectors 72 may extend from an engine case 82, across a diffuser plenum 84 surrounding the combustor 70, to a wall 86 of the combustor 70. Briefly, the combustor wall 86 may be a sidewall of the combustor 70 or a bulkhead of the combustor 70 depending on the specific combustor configuration and/or fuel injector placement. Each of the fuel injectors 72 includes a fuel nozzle 88 mated with the combustor wall 86. The fuel nozzle 88 of FIG. 3, for example, projects through (or partially into) a port 90 in the combustor wall 86.

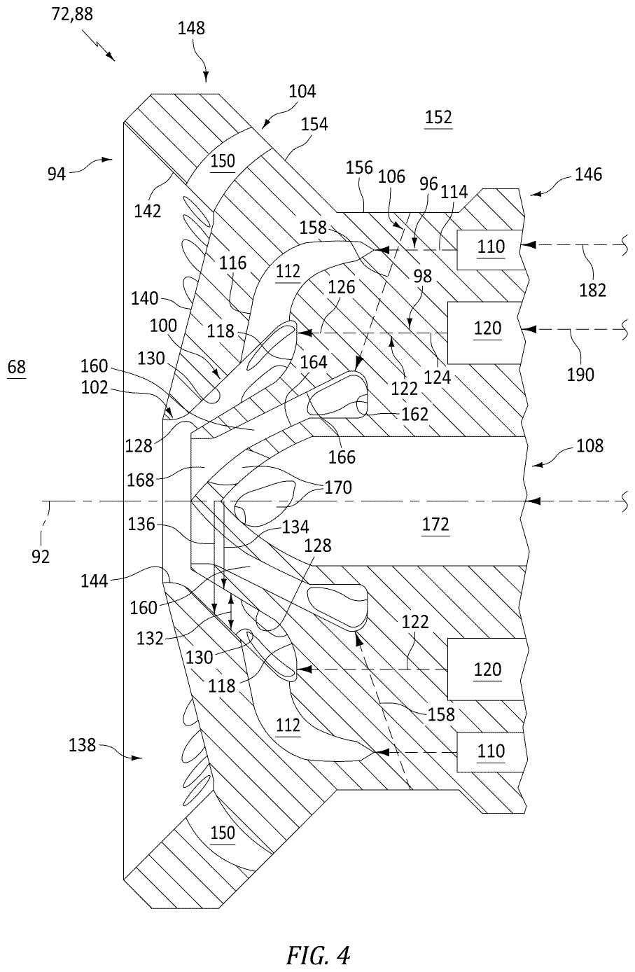

Referring to FIG. 4, the fuel nozzle 88 extends longitudinally along a longitudinal centerline 92 of the fuel nozzle 88 to a distal end 94 (e.g., a tip, a face) of the fuel nozzle 88. The fuel nozzle 88 of FIG. 4, for example, projects longitudinally along its centerline 92 through the respective combustor wall port 90 (see FIG. 3) to the nozzle distal end 94, and the nozzle distal end 94 is located within (or adjacent) the combustion chamber 68. The fuel nozzle 88 of FIG. 4 includes a gaseous fuel circuit 96, a liquid fuel circuit 98, an annular multifuel passage 100 and a nozzle outlet 102. This fuel nozzle 88 may also include one or more air circuits 104 and 106 and/or an inner fuel circuit 108; e.g., central and/or pilot fuel circuit. Briefly, the inner fuel circuit 108 may be configured as another gaseous fuel circuit or another liquid fuel circuit. However, for ease of description, the inner fuel circuit 108 may be generally described below as an inner gaseous fuel circuit of the fuel nozzle 88.

The gaseous fuel circuit 96 of FIG. 4 includes a gaseous fuel gallery 110 and one or more gaseous fuel passages 112. The gaseous fuel gallery 110 extends longitudinally within the fuel nozzle 88 between opposing longitudinally sides of the gaseous fuel gallery 110. The gaseous fuel gallery 110 extends radially within the fuel nozzle 88 between an inner side of the gaseous fuel gallery 110 and an outer side of the gaseous fuel gallery 110. The gaseous fuel gallery 110 extends circumferentially about (e.g., completely around, or substantially around) the centerline 92 within the fuel nozzle 88. The gaseous fuel gallery 110 may thereby have a full-hoop (e.g., annular) geometry, or a substantially full-hoop geometry.

The gaseous fuel passages 112 are arranged and may be equispaced circumferentially about the centerline 92 in an annular array; e.g., a circular array. Each of these gaseous fuel passages 112 extends from the gaseous fuel gallery 110 to the multifuel passage 100. Each of the gaseous fuel passages 112 thereby fluidly couples the gaseous fuel gallery 110 to the multifuel passage 100. Each gaseous fuel passage 112 of FIG. 4 includes an upstream section 114 which extends longitudinally to the downstream side of the gaseous fuel gallery 110. Here, a centerline of the gaseous fuel passage upstream section 114 may be parallel with, or close to parallel with (e.g., within plus/minus ten degrees (10°) or twenty degrees (20°) of) the centerline 92, when viewed in a reference plane parallel with (e.g., including) the centerline 92. Each gaseous fuel passage 112 of FIG. 4 further includes a downstream section 116 which extends radially (in a radial inward direction towards the centerline 92) to the multifuel passage 100, for example adjacent an upstream end 118 of the multifuel passage 100. Each gaseous fuel passage 112 may thereby be fluidly coupled to the multifuel passage 100 at (e.g., on, adjacent or proximate) the multifuel passage upstream end 118. Here, a centerline of the gaseous fuel passage downstream section 116 is angularly offset from the centerline 92 by a non-zero offset angle when viewed in the reference plane. This gaseous fuel passage downstream section offset angle may be an acute angle greater than or equal to sixty degrees (60°), seventy degrees (70°) or eighty degrees (80°).

The liquid fuel circuit 98 of FIG. 4 includes a liquid fuel gallery 120 and one or more liquid fuel passages 122. The liquid fuel gallery 120 extends longitudinally within the fuel nozzle 88 between opposing longitudinally sides of the liquid fuel gallery 120. The liquid fuel gallery 120 extends radially within the fuel nozzle 88 between an inner side of the liquid fuel gallery 120 and an outer side of the liquid fuel gallery 120. The liquid fuel gallery 120 extends circumferentially about (e.g., completely around, or substantially around) the centerline 92 within the fuel nozzle 88. The liquid fuel gallery 120 may thereby have a full-hoop (e.g., annular) geometry, or a substantially full-hoop geometry.

The liquid fuel passages 122 are arranged and may be equispaced circumferentially about the centerline 92 in an annular array; e.g., a circular array. Each of these liquid fuel passages 122 extends from the liquid fuel gallery 120 to the multifuel passage 100. Each of the liquid fuel passages 122 thereby fluidly couples the liquid fuel gallery 120 to the multifuel passage 100. Each liquid fuel passage 122 of FIG. 4 includes an upstream section 124 which extends longitudinally to the downstream side of the liquid fuel gallery 120. Here, a centerline of the liquid fuel passage upstream section 124 may be parallel with, or close to parallel with (e.g., within plus/minus five degrees (5°) of) the centerline 92, when viewed in the reference plane. Each liquid fuel passage 122 of FIG. 4 further includes a downstream section 126 which extends longitudinally to the multifuel passage upstream end 118. Each liquid fuel passage 122 may thereby be fluidly coupled to the multifuel passage 100 at the multifuel passage upstream end 118. Here, a centerline of the liquid fuel passage downstream section 126 may be parallel with, or close to parallel with (e.g., within plus/minus five degrees (5°) of) the centerline 92, when viewed in the reference plane.

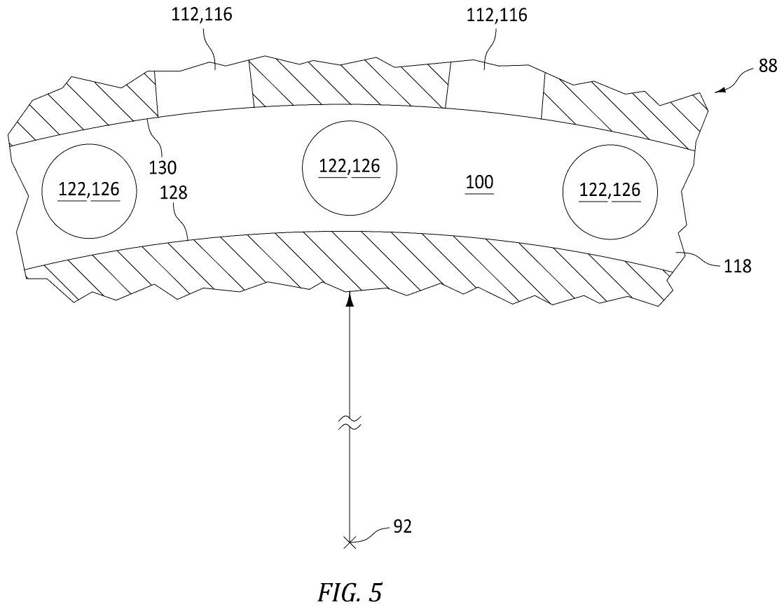

The liquid fuel circuit 98 of FIG. 4 and its members 120 and 122 are disposed radially inboard of the gaseous fuel circuit 96 and its members 110 and 112. The gaseous fuel gallery 110 of FIG. 4, for example, may longitudinally overlap and circumscribe the liquid fuel gallery 120. The array of the gaseous fuel passages 112 longitudinally overlaps and circumscribes the array of the liquid fuel passages 122. However, referring to FIG. 5, the gaseous fuel passages 112 may be circumferentially offset from the liquid fuel passages 122, at least at the multifuel passage upstream end 118. Each liquid fuel passage 122 of FIG. 5, for example, is disposed at a circumferential location between a respective neighboring pair of the gaseous fuel passages 112, where that liquid fuel passage 122 is circumferentially offset from (e.g., is completely spaced from) each of the respective neighboring pair of the gaseous fuel passages 112. The present disclosure, however, is not limited to such an exemplary arrangement at an interface between the multifuel passage 100 and the fuel circuit passages 112 and 122.

Referring to FIG. 4, the multifuel passage 100 extends longitudinally within the fuel nozzle 88 from its upstream end 118 to a longitudinal downstream end of the multifuel passage 100 at the nozzle outlet 102. The multifuel passage 100 of FIG. 4, for example, projects longitudinally and radially inward to the nozzle outlet 102. The multifuel passage 100 thereby fluidly couples (a) each of the gaseous fuel passages 112 and, thus, the gaseous fuel circuit 96 and (b) each of the liquid fuel passages 122 and, thus, the liquid fuel circuit 98 to the nozzle outlet 102. The multifuel passage 100 also extends radially from an inner side 128 of the multifuel passage 100 to an outer side 130 of the multifuel passage 100. Here, an outlet orifice from each gaseous fuel passage 112 is formed in the multifuel passage outer side 130 at the multifuel passage upstream end 118. The multifuel passage 100 extends circumferentially about (e.g., completely around) the centerline 92 within the fuel nozzle 88. The multifuel passage 100 may thereby have a full-hoop (e.g., annular) geometry.

The multifuel passage 100 of FIG. 4 may be configured as a convergent and radially tapering annulus. For example, a radial height 132 from the multifuel passage inner side 128 to the multifuel passage outer side 130 (e.g., measured perpendicular to the centerline 92) may decrease as the multifuel passage 100 extends from (or about) its upstream end 118 to (or about) the nozzle outlet 102. Moreover, each multifuel passage side 128, 130 may have a frustoconical geometry. For example, a radius 134 from the centerline 92 to the multifuel passage inner side 128 (e.g., measured perpendicular to the centerline 92) may decrease as the multifuel passage 100 extends from (or about) its upstream end 118 to (or about) the nozzle outlet 102. The multifuel passage inner side 128 is thereby angularly offset from the centerline 92 by a non-zero offset angle when viewed in the reference plane. This multifuel passage inner side offset angle may be an acute angle greater than or equal to, for example, fifteen degrees (15°) or thirty degrees (30°). A radius 136 from the centerline 92 to the multifuel passage outer side 130 (e.g., measured perpendicular to the centerline 92) may decrease as the multifuel passage 100 extends from (or about) its upstream end 118 to (or about) the nozzle outlet 102. The multifuel passage outer side 130 is thereby angularly offset from the centerline 92 by a non-zero offset angle when viewed in the reference plane, which multifuel passage outer side offset angle of FIG. 4 is greater than the multifuel passage inner side offset angle. The multifuel passage outer side offset angle may be an acute angle greater than or equal to, for example, thirty degrees (30°) or sixty degrees (60°).

The nozzle outlet 102 is disposed at the nozzle distal end 94; e.g., the fuel nozzle face. This nozzle distal end 94 may be concave with a recess 138 that projects partially into the fuel nozzle 88 at its nozzle distal end 94. The nozzle distal end 94 of FIG. 4, for example, is formed by a slanted (e.g., frustoconical) inner surface 140 and a slanted (e.g., frustoconical) outer surface 142. The inner surface 140 extends longitudinally (in a direction towards the fuel galleries 110, 120/away from the combustion chamber 68) and radially outward from the nozzle outlet 102 to the outer surface 142. The outer surface 142 extends longitudinally (in a direction away from the fuel galleries 110, 120/towards the combustion chamber 68) and radially outward from the inner surface 140 towards or to an outer periphery of the fuel nozzle 88. Note, while an inner edge of the inner surface 140 is shown in FIG. 4 as being axially recessed from an outer edge of the outer surface 142, it is contemplated these edges may alternatively be axially aligned or the outer edge of the outer surface 142 may be axially recess from the inner edge of the inner surface 140.

The nozzle outlet 102 of FIG. 4 extends longitudinally along the centerline 92 within the fuel nozzle 88 from the multifuel passage 100 and its downstream end to the recess 138 and the inner surface 140. The nozzle outlet 102 of FIG. 4 thereby fluidly couples the multifuel passage 100 to the combustion chamber 68, for example through the recess 138 at the nozzle distal end 94. The nozzle outlet 102 of FIG. 4 projects radially outward within the fuel nozzle 88 from the centerline 92 to an outer side 144 of the nozzle outlet 102. This nozzle outlet outer side 144 may be parallel with, or close to parallel with (e.g., within plus/minus fifteen degrees (15°) of) the centerline 92, when viewed in the reference plane. The nozzle outlet 102 extends circumferentially about (e.g., completely around) the centerline 92 within the fuel nozzle 88. The nozzle outlet 102 may thereby have a solid (e.g., non-annular) geometry; e.g., a solid circular geometry.

The outer air circuit 104 may be disposed radially outboard of and may longitudinally overlap one or more of the fuel nozzle members 96, 100, 102, 106 and/or 108. These fuel nozzle members 96, 100, 102, 106 and/or 108 as well as the liquid fuel circuit 98 of FIG. 4, for example, are configured in a base 146 of the fuel nozzle 88. The outer air circuit 104 of FIG. 4, by contrast, is configured in an outer peripheral wall 148 (e.g., a flange) of the fuel nozzle 88. This nozzle wall 148 is disposed at the nozzle distal end 94 and may form the outer surface 142 of the nozzle distal end 94. The nozzle wall 148 is connected to (e.g., formed integral with or otherwise attached to) the nozzle base 146. The nozzle wall 148 of FIG. 4 projects radially outward and longitudinally (in the direction away from the fuel galleries 110, 120/towards the combustion chamber 68) out from the nozzle base 146 to an outer distal end of the nozzle wall 148.

The outer air circuit 104 of FIG. 4 includes one or more outer air passages 150. These outer air passages 150 are arranged and may be equispaced circumferentially about the centerline 92 in an annular array; e.g., a circular array. Each of these outer air passages 150 extends through the nozzle wall 148 from an internal volume 152 adjacent a backside 154 of the nozzle wall 148/an outer side 156 of the nozzle base 146 to the outer surface 142 and the recess 138. The outer air circuit 104 and its outer air passages 150 thereby fluidly couple the internal volume 152 to the combustion chamber 68 through the recess 138 at the nozzle distal end 94. Referring to FIG. 3, the internal volume 152 may be a cavity within the respective fuel injector 72 which fluidly couples the diffuser plenum 84 to the outer air circuit 104 and the inner air circuit 106. Alternatively, the internal volume 152 may be the diffuser plenum 84 itself or another air source within the turbine engine 26 and outside of the combustor 70.

The outer air circuit 104 and its outer air passages 150 may be configured to direct air received from the internal volume 152 into the recess 138 and/or the combustion chamber 68 in a radially inward direction towards the centerline 92. For example, each outer air passage 150 may turn radially inward as that outer air passage 150 extends through the nozzle wall 148. At a respective outlet orifice in the outer surface 142, a centerline of each outer air passage 150 may be angularly offset from the centerline 92 by a non-zero offset angle when viewed in the reference plane. This outer air passage offset angle may be an acute angle greater than the multifuel passage inner side offset angle and/or the multifuel passage outer side offset angle. Here, a trajectory of the air directed out from each of the outer air passages 150 may be within five degrees (5°), ten degrees (10°) or fifteen degrees (15°) of parallel to the outer surface 142 when viewed in the reference plane. The present disclosure, however, is not limited to such an exemplary arrangement.

The inner air circuit 106 may be disposed radially inboard of and may be longitudinally overlapped by one or more of the fuel nozzle members 96, 98 and/or 100. The inner air circuit 106 may be disposed radially outboard of and may longitudinally overlap the inner fuel circuit 108. The inner air circuit 106 of FIG. 4 includes one or more inner air passages 158 and an annular inner nozzle passage 160.

The inner air passages 158 are arranged and may be equispaced circumferentially about the centerline 92 in an annular array; e.g., a circular array. Each of these inner air passages 158 extends from the internal volume 152 to the inner nozzle passage 160. More particularly, each inner air passage 158 of FIG. 4 projects radially inward and longitudinally along the centerline 92 (in the direction away from the fuel galleries 110, 120/towards the combustion chamber 68) into the nozzle base 146 from the nozzle base outer side 156 to the inner nozzle passage 160, for example adjacent an upstream end 162 of the inner nozzle passage 160. Each inner air passage 158 may thereby be fluidly coupled to the inner nozzle passage 160 at the inner nozzle passage upstream end 162. Here, a centerline of each inner air passage 158 is angularly offset from the centerline 92 by a non-zero offset angle when viewed in the reference plane. This inner nozzle passage offset angle may be an acute angle between sixty degrees (60°) and eighty degrees (80°).

The inner nozzle passage 160 extends longitudinally within the fuel nozzle 88 from its upstream end 162 to a longitudinal downstream end of the inner nozzle passage 160 at the nozzle outlet 102. The inner nozzle passage 160 of FIG. 4, for example, projects longitudinally and radially inward to the nozzle outlet 102. The inner nozzle passage 160 thereby fluidly couples (a) each of the inner air passages 158 and (b) the inner fuel circuit 108 to the nozzle outlet 102. In turn, the nozzle outlet 102 further fluidly couples the inner air circuit 106 and the inner fuel circuit 108 to the combustion chamber 68 through the recess 138. The inner nozzle passage 160 extends radially from an inner side 164 of the inner nozzle passage 160 to an outer side 166 of the inner nozzle passage 160. Here, an outlet orifice from each inner air passage 158 is formed in the inner nozzle passage outer side 166 at the inner nozzle passage upstream end 162. The inner nozzle passage 160 extends circumferentially about (e.g., completely around) the centerline 92 within the fuel nozzle 88. The inner nozzle passage 160 may thereby have a full-hoop (e.g., annular) geometry. The inner nozzle passage 160 of FIG. 4 is configured as a radially tapering annulus with a divergent section 168 adjacent the nozzle outlet 102. Here, the divergent section 168 is aligned with one or more outlets 170 from the inner fuel circuit 108.

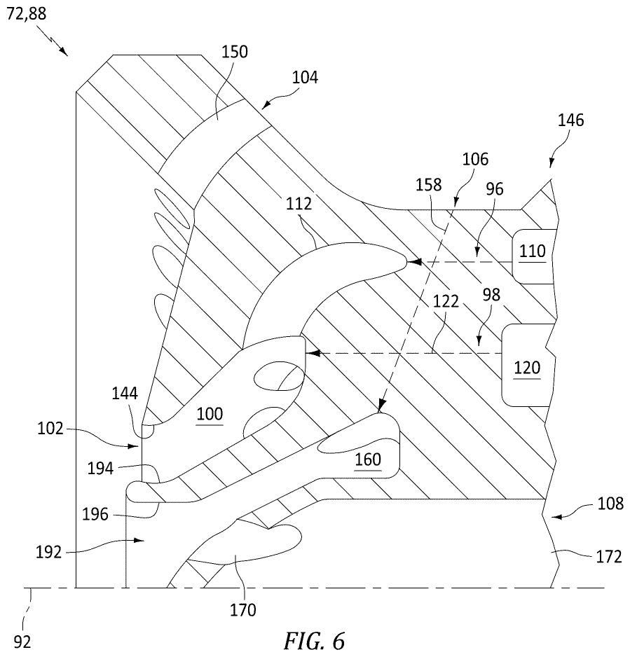

The inner fuel circuit 108 of FIG. 4 includes an inner fuel feed passage 172 and its one or more inner fuel outlets 170. The inner fuel feed passage 172 may be configured as a central bore in the fuel nozzle 88. The inner fuel outlets 170 are arranged and may be equispaced circumferentially about the centerline 92 in an annular array; e.g., a circular array. Each of the inner fuel outlets 170 projects through an endwall of the nozzle base 146 at a downstream end of the inner fuel feed passage 172. Each of the inner fuel outlets 170 thereby fluidly couples the inner fuel feed passage 172 to the nozzle outlet 102 through the divergent section 168 of the inner nozzle passage 160. A centerline of each of the inner fuel outlets 170 may be angularly offset from the centerline 92 by a non-zero offset angle when viewed in the reference plane so as to direct fuel out of the respective inner fuel outlet 170 in a (e.g., slight) radial outward direction. The inner fuel outlet offset angle, for example, may be an acute angle less than or equal to forty-five degrees (45°), thirty degrees (30°), or fifteen degrees (15°). The present disclosure, however, is not limited to such an exemplary arrangement. The centerline 92 of each of the inner fuel outlets 170, for example, may alternatively be parallel to the centerline 92; e.g., see FIG. 6.

Referring to FIG. 2, the gaseous fuel source 74 includes a fuel reservoir 174, a fuel flow regulator 176 and a fuel evaporator 178. The fuel reservoir 174 is configured to store a quantity of fuel (e.g., in its liquid phase) before, during and/or after aircraft powerplant operation. The fuel reservoir 174, for example, may be configured as or otherwise include a tank, a cylinder, a pressure vessel, a bladder or any other type of (e.g., insulated) fuel storage container. The fuel flow regulator 176 is configured to direct a flow of the fuel (e.g., in its liquid phase) from the fuel reservoir 174 to the fuel evaporator 178. The fuel flow regulator 176, for example, may be configured as or otherwise include a fuel compressor, a fuel pump and/or a fuel valve (or valve system). The fuel evaporator 178 is configured to facilitate evaporation of the fuel from its liquid phase to a gaseous phase so as to output the gaseous fuel from an outlet 180 of the gaseous fuel source 74. This gaseous fuel source outlet 180 may be fluidly coupled to the gaseous fuel circuit 96 (see FIG. 4) sequentially through the gaseous fuel manifold 78 and a respective gaseous fuel feed passage 182, which gaseous fuel feed passage 182 fluidly couples the gaseous fuel manifold 78 to the gaseous fuel gallery 110 (see FIG. 4). The gaseous fuel source outlet 180 may also be fluidly coupled to the inner fuel circuit 108 (see FIG. 4) sequentially through the gaseous fuel manifold 78 and the respective inner fuel feed passage 172 (see FIG. 4), or through another fuel manifold.

The gaseous fuel may be a non-hydrocarbon gas. The gaseous fuel, for example, may be or otherwise include hydrogen gas (H₂ gas), and the fuel stored within the fuel reservoir 174 may be liquid hydrogen (liquid H₂). The gaseous fuel, however, is not limited to non-hydrocarbon gases. The gaseous fuel, for example, may alternatively by or otherwise include gaseous methane (e.g., natural gas) or propane. However, use of the non-hydrocarbon gas such as the hydrogen gas may be particularly beneficial for reduction in emissions from the turbine engine 26 (see FIG. 1). The gaseous fuel may therefore be generally described below as the hydrogen gas for ease of description.

Referring to FIG. 2, the liquid fuel source 76 includes a fuel reservoir 184 and a fuel flow regulator 186. The fuel reservoir 184 is configured to store a quantity of fuel (e.g., in its liquid phase) before, during and/or after aircraft powerplant operation. The fuel reservoir 184, for example, may be configured as or otherwise include a tank, a cylinder, a pressure vessel, a bladder or any other type of fuel storage container. The fuel flow regulator 186 is configured to direct a flow of the fuel (e.g., in its liquid phase) from the fuel reservoir 184 to an outlet 188 of the liquid fuel source 76. The fuel flow regulator 186, for example, may be configured as or otherwise include a fuel pump and/or a fuel valve (or valve system). This liquid fuel source outlet 188 may be fluidly coupled to the liquid fuel circuit 98 (see FIG. 4) sequentially through the liquid fuel manifold 80 and a respective liquid fuel feed passage 190, which liquid fuel feed passage 190 fluidly couples the liquid fuel manifold 80 to the liquid fuel gallery 120 (see FIG. 4).

The liquid fuel may be a hydrocarbon liquid. The liquid fuel, for example, may be or otherwise include kerosene, jet fuel (e.g., Jet A fuel), sustainable aviation fuel (SAF) or any other power-to-liquid (PTL) fuel, or the like. The present disclosure, however, is not limited to the foregoing exemplary liquid fuels, nor to hydrocarbon liquids.

The fuel delivery system 28 is configured to operate in one or more modes of operation. These modes of operation may include, but are not limited to, a gaseous fuel mode, a liquid fuel mode and a multifuel mode. This multifuel mode may be utilized for transitioning between operating in the gaseous fuel mode and the liquid fuel mode. The multifuel mode may also or alternatively be utilized for sustained turbine engine operation using both the gaseous fuel and the liquid fuel.

Referring to FIGS. 2 and 4, when operating in the gaseous fuel mode, each fuel nozzle 88 receives the gaseous fuel from the gaseous fuel source 74. This gaseous fuel is directed through the gaseous fuel circuit 96 and into the multifuel passage 100. The multifuel passage 100 subsequently directs the gaseous fuel out of the fuel nozzle 88 (through the nozzle outlet 102) and into the combustion chamber 68 as an annular or substantially annular flow of the gaseous fuel. Here, the multifuel passage inner side 128 may be configured (e.g., shaped, inclined, etc.) to tailor the flow of the gaseous fuel into the combustion chamber 68. During this gaseous fuel mode, the gaseous fuel may also be directed out of the inner fuel circuit 108 and through the nozzle outlet 102 and into the combustion chamber 68 as an inner flow of the gaseous fuel. Simultaneously, the outer air circuit 104 and the inner air circuit 106 may direct a portion of the compressed core air received from the internal volume 152 into the combustion chamber 68. This compressed core air may mix with the flows of the gaseous fuel (e.g., within the combustion chamber 68) to provide the fuel-air mixture for combustion. During this gaseous fuel mode, the fuel delivery system 28 in general provides the gaseous fuel to the fuel injectors 72 without the liquid fuel. Thus, in the gaseous fuel mode, the turbine engine 26 and its combustor 70 may be running (e.g., only) on the gaseous fuel.

For ease of description, both the gaseous fuel circuit 96 and the inner fuel circuit 108 are described as injecting the gaseous fuel into the combustion chamber 68 simultaneously. It is contemplated, however, the fuel delivery system 28 may also or alternatively provide the gaseous fuel to the gaseous fuel circuit 96 (and not the inner fuel circuit 108) during one or more modes of operation. It is contemplated the fuel delivery system 28 may also or alternatively provide the gaseous fuel to the inner fuel circuit 108 (and not the gaseous fuel circuit 96) during one or more other modes of operation.

When operating in the liquid fuel mode, each fuel nozzle 88 receives the liquid fuel from the liquid fuel source 76. This liquid fuel is directed through the liquid fuel circuit 98 and into the multifuel passage 100. The multifuel passage 100 subsequently directs the liquid fuel out of the fuel nozzle 88 (through the nozzle outlet 102) and into the combustion chamber 68 as an annular or substantially annular flow of the liquid fuel. Here, the multifuel passage outer side 130 may function as a filmer and may be configured (e.g., shaped, inclined, etc.) to tailor the flow of the liquid fuel into the combustion chamber 68. For example, the liquid fuel may form a film on the multifuel passage outer side 130. Simultaneously, the outer air circuit 104 and the inner air circuit 106 may direct a portion of the compressed core air received from the internal volume 152 into the combustion chamber 68 to form inner and outer layers of air on either side of the liquid fuel film to facilitate atomization. This compressed core air may mix with the flow of the liquid fuel (e.g., within the combustion chamber 68) to provide the fuel-air mixture for combustion. During this liquid fuel mode, the fuel delivery system 28 in general provides the liquid fuel to the fuel injectors 72 without the gaseous fuel. Thus, in the liquid fuel mode, the turbine engine 26 and its combustor 70 may be running (e.g., only) on the liquid fuel.

When operating in the multifuel mode, each fuel nozzle 88 receives the gaseous fuel from the gaseous fuel source 74 and the liquid fuel from the liquid fuel source 76. The gaseous fuel is directed through and then out of the fuel nozzle 88 as described above. Similarly, the liquid fuel is directed through and then out of the fuel nozzle 88 as described above. The fuel-air mixture within the combustion chamber 68 may thereby include a mixture of both the gaseous fuel and the liquid fuel for combustion with the compressed core air. Simultaneously, the outer air circuit 104 and the inner air circuit 106 may direct a portion of the compressed core air received from the internal volume 152 into the combustion chamber 68. This compressed core air may mix with the flows of the gaseous and the liquid fuels (e.g., within the combustion chamber 68) to provide the fuel-air mixture for combustion.

In some embodiments, referring to FIG. 4, the gaseous fuel circuit 96, the liquid fuel circuit 98, the inner air circuit 106 and the inner fuel circuit 108 may share a common outlet from the fuel nozzle 88—the nozzle outlet 102. In other embodiments, referring to FIG. 6, the gaseous fuel circuit 96 and the liquid fuel circuit 98 may share the common nozzle outlet 102—an outer nozzle outlet. The inner air circuit 106 and the inner fuel circuit 108, by contrast, may share another common nozzle outlet 192—an inner nozzle outlet. Here, the outer nozzle outlet 102 and the inner nozzle outlet 192 are separated by a tubular barrier wall of the nozzle base 146. With this arrangement, the fuel nozzle 88 may be configured to direct the gaseous fuel received from the multifuel passage 100 into the combustion chamber 68 along a different trajectory than the liquid fuel received from the multifuel passage 100. Here, the outer nozzle outlet 102 is annular and extends radially between an inner side 194 of the outer nozzle outlet 102 to the outer side 144 of the outer nozzle outlet 102. The inner nozzle outlet 192, by contrast, is solid (e.g., non-annular) and extends radially out from the centerline 92 to an outer side 196 of the inner nozzle outlet 192.

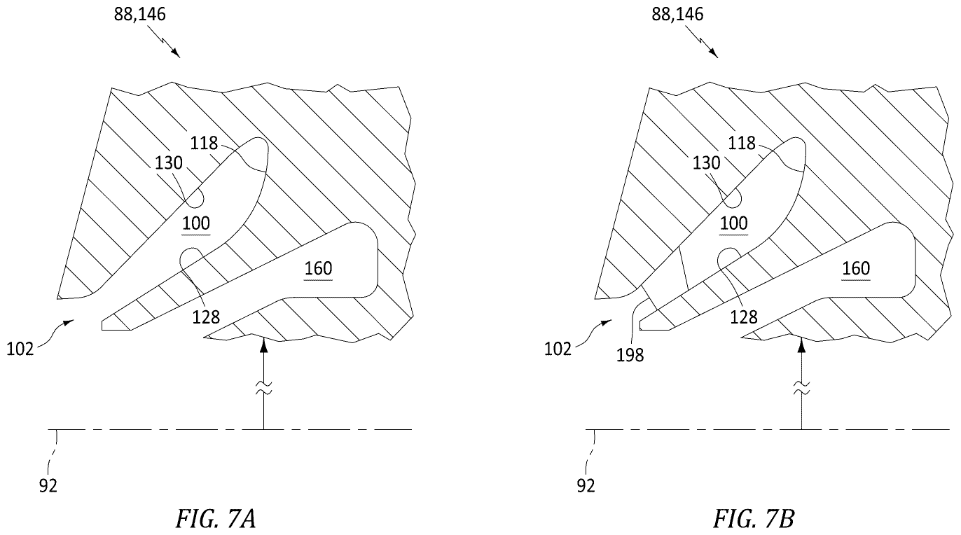

In some embodiments, referring to FIG. 7A, the multifuel passage 100 may be circumferentially and/or longitudinally uninterrupted. The multifuel passage 100 of FIG. 7A, for example, is configured without any guide vanes (e.g., swirler vanes) extending thereacross. In other embodiments, referring to FIG. 7B, the multifuel passage 100 may be configured with one or more guide vanes 198. These guide vanes 198 are arranged and may be equispaced circumferentially about the centerline 92 in an annular array; e.g., a circular array. Each of the guide vanes 198 extends radially across the multifuel passage 100 from the multifuel passage inner side 128 to the multifuel passage outer side 130. Here, the array of the guide vanes 198 is proximate, but spaced longitudinally from the nozzle outlet 102.

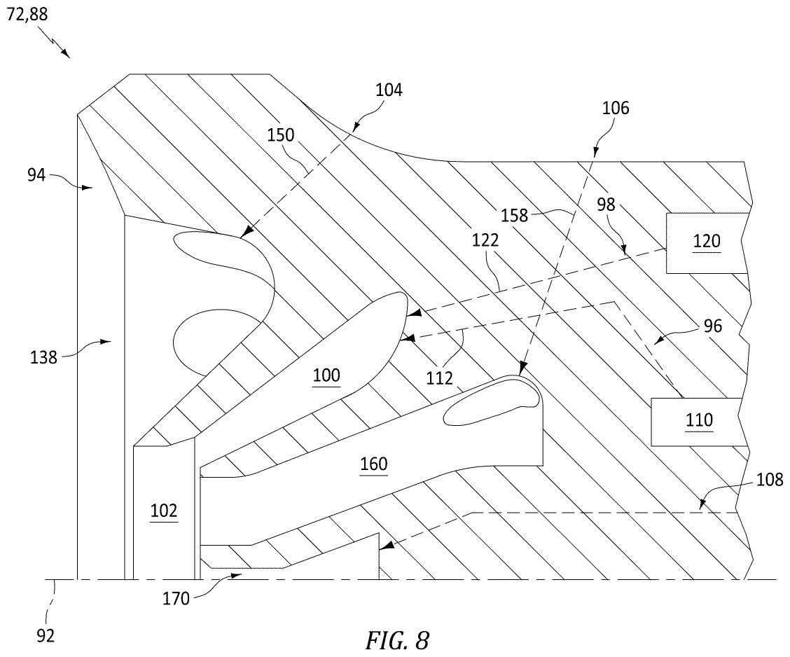

In some embodiments, referring to FIGS. 4 and 6, each of the gaseous fuel passages 112 may extend radially inwards to the multifuel passage 100. In other embodiments, referring to FIG. 8, each of the gaseous fuel passages 112 may extend longitudinally along the centerline 92 to the multifuel passage 100.

In some embodiments, referring to FIGS. 4 and 6, the gaseous fuel circuit 96 may be disposed radially outboard of the liquid fuel circuit 98. In other embodiments, referring to FIG. 8, the gaseous fuel circuit 96 may be disposed radially inboard of the liquid fuel circuit 98.

In some embodiments, each fuel nozzle 88 may be formed as a monolithic body. Each fuel nozzle 88, for example, may be cast, machined, additively manufactured and/or otherwise formed as a single unitary body. In other embodiments, however, each fuel nozzle 88 may alternatively be formed from a plurality of discretely formed members which are subsequently bonded, mechanically fastened and/or otherwise attached together to form the respective fuel nozzle 88.

While various embodiments of the present disclosure have been described, it will be apparent to those of ordinary skill in the art that many more embodiments and implementations are possible within the scope of the disclosure. For example, the present disclosure as described herein includes several aspects and embodiments that include particular features. Although these features may be described individually, it is within the scope of the present disclosure that some or all of these features may be combined with any one of the aspects and remain within the scope of the disclosure. Accordingly, the present disclosure is not to be restricted except in light of the attached claims and their equivalents.

What is claimed is:

1. An apparatus for a powerplant, comprising:
a fuel nozzle extending longitudinally along a centerline to a distal end, the fuel nozzle including a plurality of gaseous fuel passages, a plurality of liquid fuel passages, an annular passage and a nozzle outlet disposed at the distal end of the fuel nozzle;
the plurality of gaseous fuel passages arranged circumferentially about the centerline, each of the plurality of gaseous fuel passages extending within the fuel nozzle to the annular passage;
the plurality of liquid fuel passages arranged circumferentially about the centerline, each of the plurality of liquid fuel passages extending within the fuel nozzle to the annular passage; and
the annular passage extending circumferentially around the centerline, the annular passage fluidly coupling the plurality of gaseous fuel passages and the plurality of liquid fuel passages to the nozzle outlet.

2. The apparatus of claim 1, wherein a radial height of the annular passage decreases as the annular passage extends longitudinally along the centerline in a direction towards the nozzle outlet.

3. The apparatus of claim 1, wherein
the annular passage extends radially between an inner side and an outer side; and
a radius from the centerline to the inner side of the annular passage decreases as the annular passage extends longitudinally to the nozzle outlet.

4. The apparatus of claim 1, wherein
the annular passage extends radially between an inner side and an outer side; and
a radius from the centerline to the outer side of the annular passage decreases as the annular passage extends longitudinally to the nozzle outlet.

5. The apparatus of claim 1, wherein the nozzle outlet extends radially from the centerline to an outer side of the nozzle outlet.

6. The apparatus of claim 5, wherein the outer side of the nozzle outlet is at least within fifteen degrees of parallel of the centerline when viewed in a reference plane parallel with the centerline.

7. The apparatus of claim 1, wherein the nozzle outlet extends radially between an inner side of the nozzle outlet and an outer side of the nozzle outlet.

8. The apparatus of claim 7, wherein at least one of
the inner side of the nozzle outlet is at least within fifteen degrees of parallel of the centerline when viewed in a reference plane parallel with the centerline; or
the outer side of the nozzle outlet is at least within fifteen degrees of parallel of the centerline when viewed in the reference plane.

9. The apparatus of claim 1, wherein
the fuel nozzle further includes a plurality of vanes disposed within the annular passage and arranged circumferentially about the centerline; and
each of the plurality of vanes extends radially across the annular passage.

10. The apparatus of claim 1, wherein
the annular passage extends longitudinally along the centerline from an upstream end to the nozzle outlet;
the plurality of gaseous fuel passages are fluidly coupled to the annular passage at the upstream end of the annular passage; and
the plurality of liquid passages are fluidly coupled to the annular passage at the upstream end of the annular passage.

11. The apparatus of claim 1, wherein
the plurality of gaseous fuel passages comprise a first gaseous fuel passage; and
the first gaseous fuel passage extends radially inward towards the centerline to the annular passage.

12. The apparatus of claim 1, wherein
the plurality of gaseous fuel passages comprise a first gaseous fuel passage; and
the first gaseous fuel passage extends longitudinally along the centerline to the annular passage.

13. The apparatus of claim 1, wherein
the fuel nozzle further includes a gaseous fuel gallery extending circumferentially about the centerline; and
each of the plurality of gaseous fuel passages extends from the gaseous fuel gallery to the annular passage.

14. The apparatus of claim 1, wherein
the plurality of liquid fuel passages comprise a first liquid fuel passage; and
the first liquid fuel passage extends longitudinally along the centerline to the annular passage.

15. The apparatus of claim 1, wherein
the fuel nozzle further includes a liquid fuel gallery extending circumferentially about the centerline; and
each of the plurality of liquid fuel passages extends from the liquid fuel gallery to the annular passage.

16. The apparatus of claim 1, further comprising:
a fuel system including a gaseous fuel source and a liquid fuel source;
the fuel system configured to deliver gaseous fuel from the gaseous fuel source to the fuel nozzle for directing through the plurality of gaseous fuel passages; and
the fuel system configured to deliver liquid fuel from liquid fuel source to the fuel nozzle for directing through the plurality of liquid fuel passages.

17. The apparatus of claim 1, wherein
the annular passage is a first annular passage, and the fuel nozzle further includes a plurality of air passages and a second annular passage;
the plurality of air passages are arranged circumferentially about the centerline, and each of the plurality of air passages extends within the fuel nozzle to the second annular passage; and
the first annular passage circumscribes the second annular passage.

18. The apparatus of claim 1, wherein
the fuel nozzle further includes a plurality of air passages and a recess which extends longitudinally into the fuel nozzle at the distal end of the fuel nozzle;
the plurality of air passages are arranged circumferentially about the centerline, and each of the plurality of air passages extends through a wall of the fuel nozzle to the recess; and
the recess fluidly couples the nozzle outlet and the plurality of air passages to an environment external to the fuel nozzle.

19. An apparatus for an aircraft powerplant, comprising:
a fuel nozzle extending longitudinally along a centerline to a distal end, the fuel nozzle including a plurality of first fuel passages, a plurality of second fuel passages, a first fuel gallery, a second fuel gallery, an annular passage and a nozzle outlet disposed at the distal end of the fuel nozzle;
the plurality of first fuel passages arranged circumferentially about the centerline, each of the plurality of first fuel passages extending within the fuel nozzle from the first fuel gallery to the annular passage;
the plurality of second fuel passages arranged circumferentially about the centerline, each of the plurality of second fuel passages extending within the fuel nozzle from the second fuel gallery to the annular passage; and
the annular passage extending circumferentially around the centerline, the annular passage fluidly coupling the plurality of first fuel passages and the plurality of second fuel passages to the nozzle outlet, and the annular passage radially tapering towards the centerline as the annular passage extends longitudinally towards the nozzle outlet.

20. An apparatus for an aircraft powerplant, comprising:
a fuel nozzle extending longitudinally along a centerline to a distal end, the fuel nozzle including a plurality of first fuel passages, a plurality of second fuel passages, an annular passage and a nozzle outlet disposed at the distal end of the fuel nozzle;
the plurality of first fuel passages arranged circumferentially about the centerline, each of the plurality of first fuel passages extending within the fuel nozzle, in a radial inward direction towards the centerline, to the annular passage;
the plurality of second fuel passages arranged circumferentially about the centerline, each of the plurality of second fuel passages extending within the fuel nozzle, in a longitudinal direction towards the distal end of the fuel nozzle, to the annular passage; and
the annular passage extending circumferentially around the centerline, the annular passage fluidly coupling the plurality of first fuel passages and the plurality of second fuel passages to the nozzle outlet, and the annular passage radially tapering towards the centerline as the annular passage extends longitudinally to the nozzle outlet.
